(19) United States
(12) Patent Application Publication
(10) Pub. No.: US 2005/0184972 A1
(43) Pub. Date: Aug. 25, 2005

(54) Image display apparatus and image display method

(75) Inventors: Kei Tashiro, Tokyo (JP); Tatsuro Abe, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KABUSHIKI KAISHA TOSHIBA

(21) Appl. No.: 11/052,744

(22) Filed: Feb. 9, 2005

(30) Foreign Application Priority Data
Feb. 20, 2004 (JP) 2004/45127

(51) Int. Cl. G09G 5/00

(52) U.S. Cl. 345/173

(57) ABSTRACT

An image display apparatus including a liquid crystal panel for displaying an image-picked-up image, a touch panel on an image display screen of the liquid crystal panel, and a microcomputer having a display area setting unit that, when the image display screen of the liquid crystal panel is covered by a user's finger, detects the finger position on the touch panel and sets an image display area on the image display screen of the liquid crystal panel in accordance with the detected user's finger position.

### CROSS-REFERENCE TO RELATED APPLICATIONS

This application is based upon and claims the benefit of priority from the prior Japanese Patent Application No. 2004-45127, filed on Feb. 20, 2004; the entire contents of which are incorporated herein by reference.

### BACKGROUND OF THE INVENTION

1. Field of the Invention

The present invention relates to an image display apparatus and image display method in and by which an image display area on a liquid crystal display panel or the like for displaying still images and moving images can be set freely.

2. Description of the Related Art

In recent years, a mobile image display apparatus of a digital camera, a mobile information terminal apparatus (such as a PDA) and a mobile image viewer or the like has been a liquid crystal display panel functioning as a video display device displaying still images and moving images. A mobile image display apparatus may be a liquid crystal display panel having a large image display screen in order to enhance the viewability of a displayed image with the entire form in a reduced size.

However, a conventional image display apparatus of a digital camera, for example, has an optical lens, metering and distance-measuring portions, a flash on the front face and a shutter button and zoom button and the like on the top face, and a liquid crystal display panel for displaying an image-picked-up image and operation mode keys for selecting and setting various image-picking-up operation functions on the back face. The size of the liquid crystal display panel on the back face of the digital camera is set in conjunction with the operation mode keys.

A digital camera has been proposed which has a liquid crystal display panel having a touch panel in order to reduce a space having operation mode keys of the digital camera and increase the size of the liquid crystal display panel. In this case, the liquid crystal display panel can display an image-picked-up image and icons for various operation modes. A user can set an operation mode by touching an icon for an operation mode displayed on the liquid crystal display panel having a touch panel. Japanese Published Patent Application No. 2003-338975 (which will be called Document 1, hereinafter) discloses a digital camera having a liquid crystal display panel having a touch panel.

The digital camera disclosed in Document 1 can recognize a pattern traced on a touch panel screen of the liquid crystal display panel having a touch panel by a finger and allows setting or changing a display mode such as forwarding/backing and deleting an image-picked-up image, zooming an image, and displaying a thumbnail. Allowing changing or setting a display mode on a liquid crystal display panel having a touch panel can minimize a space for operation mode keys.

A digital camera having a liquid crystal display panel having a touch panel will be described with reference to FIG. 10. A digital camera (simply called camera, hereinafter) 10 has a shutter button 21 on the top face, an optical lens, light-measuring and distance measuring portions and a flash on the front face, not shown, a liquid crystal display panel 18 displaying an image-picked-up image 30 on a substantially entire area of the back face and a touch panel 20 on the surface of the liquid crystal display panel 18. The camera 10 self-contains a solid-state image pickup device and a digital camera functioning portion. In this case, the solid-state image pickup device optoelectronically converts a subject from an optical lens. The digital camera functioning portion performs predetermined signal processing on image-picked-up image signals optoelectronically converted by the solid-state-image pickup device and displays an image on the liquid crystal display panel 18 and/or stores an image in a recording medium.

The camera 10 has the liquid crystal display panel 18 having a large image display screen having the touch panel 20 on the entire area of the back face to enhance viewability of a displayed image and allows a user to select and set an operation mode by touching the touch panel 20.

FIGS. 11A and 11B illustrate image-picking-up operations in the camera 10 having the liquid crystal display panel 18 occupying a substantially entire area of the back face. A user may pick-up images by holding the camera 10 with the right hand 55a only, for example, as shown in FIG. 11A or by holding the camera 10 with both hands of the right hand 55a and left hand 55b as shown in FIG. 11B.

As shown in FIG. 11B, when the camera 10 is held with the left and right hands 55a and 55b, the index finger of the right hand 55a is placed on the shutter button 21 while the other fingers of the left and right hands 55a and 55b hold top and bottom surfaces of the camera 10 along both sides of the camera 10. When the camera 10 is held with the both hands 55a and 55b, a user can view an entire display area of an image-picked-up image 30 displayed on the liquid crystal display panel 18.

However, as shown in FIG. 11A, when the camera 10 is held only with the right hand 55a, the index finger of the right hand 55a is placed on the shutter button 21, the thumb finger on the display screen of the liquid crystal display panel 18, the second finger, third finger and little finger, not shown, on the front face of the camera 10. That is, the camera 10 is held between the thumb finger and the second finger, third finger and little finger. Since the thumb finger is placed on the liquid crystal display panel 18 when the camera 10 is held with the right hand 55a, a part of the image-picked-up image 30 being displayed is covered by the thumb finger.

A user image-picking-up a subject often performs operations not with both hands, which is inconvenient, but with one hand. When the camera 10 having the liquid crystal display panel 18 having the touch panel in a substantially entire area of the back face is operated with one hand, a part of an image-picked-up image is covered by the thumb finger on the image display screen of the liquid crystal display panel 18, which may deteriorate viewability of the image by a user.

### SUMMARY OF THE INVENTION

Accordingly, it is an object of the present invention to provide an image display apparatus and image display method allowing changing and setting a display area of an image such that the image cannot be covered by a finger placed on a liquid crystal display panel displaying an image.

According to one aspect of the invention, there is provided an image display apparatus comprising a display unit for displaying a still image or moving images, a position detecting unit for detecting a position of an object touching an image display screen of the display unit, and a display area setting unit for setting a display area of an image to be displayed on the image display screen of the display unit in accordance with a position touched by an object, which is detected by the position detecting unit.

According to another aspect of the invention, there is provided an image display apparatus comprising a display unit displaying a still image or moving images, a forceful display area setting mode unit for setting an image display area of the display unit forcefully, a position detecting unit for detecting an area of an image display area commanded on the image display screen of the display unit set by the forceful display area setting mode unit, and a display area setting unit for setting a display area of an image to be displayed on the image display screen of the display unit in accordance with an image display range detected by the position detecting unit.

The above and other objects, features and advantages of the invention will become more clearly understood from the following description referring to the accompanying drawings.

### BRIEF DESCRIPTION OF THE DRAWINGS

FIG. 1 is a block diagram showing a construction of a digital camera, which is an image display apparatus according to an embodiment of the invention;

FIG. 2 is an explanatory diagram for explaining the back face of the digital camera, which is an image display apparatus according to the embodiment of the invention;

FIG. 3 is an explanatory diagram for explaining a setting for an image display area of a liquid crystal display panel on the back face of the digital camera, which is an image display apparatus according to the embodiment of the invention;

FIG. 4 is a flowchart illustrating a position detecting operation to be performed when the liquid crystal display panel of the digital camera, which is an image display apparatus according to the embodiment of the invention, is touched by a finger;

FIG. 5 is a flowchart illustrating an operation for setting an image display area based on a detected position when the liquid crystal display panel of the digital camera, which is an image display apparatus according to the embodiment of the invention, is touched by a finger;

FIG. 6 is an explanatory diagram for explaining an operation for manually setting an image display area of the liquid crystal display panel of the digital camera, which is an image display apparatus according to the embodiment of the invention;

FIGS. 7A to 7D are explanatory diagrams for explaining a set position of an image display area on the liquid crystal display panel of the digital camera, which is an image display apparatus according to the embodiment of the invention;

FIG. 8 is an explanatory diagram for explaining an example of displaying an icon on a non-image display area to be displayed on the liquid crystal display panel of the digital camera, which is an image display apparatus according to the embodiment of the invention;

FIG. 9 is an explanatory diagram for explaining an image display area selecting function menu to be displayed on the liquid crystal display panel of the digital camera, which is an image display apparatus according to the embodiment of the invention;

FIG. 10 is an explanatory diagram for explaining a liquid crystal display panel on the back face of the digital camera; and

FIGS. 11A and 11B are explanatory diagrams for explaining how the digital camera is held during an image-picking-up operation.

### DESCRIPTION OF THE PREFERRED EMBODIMENTS

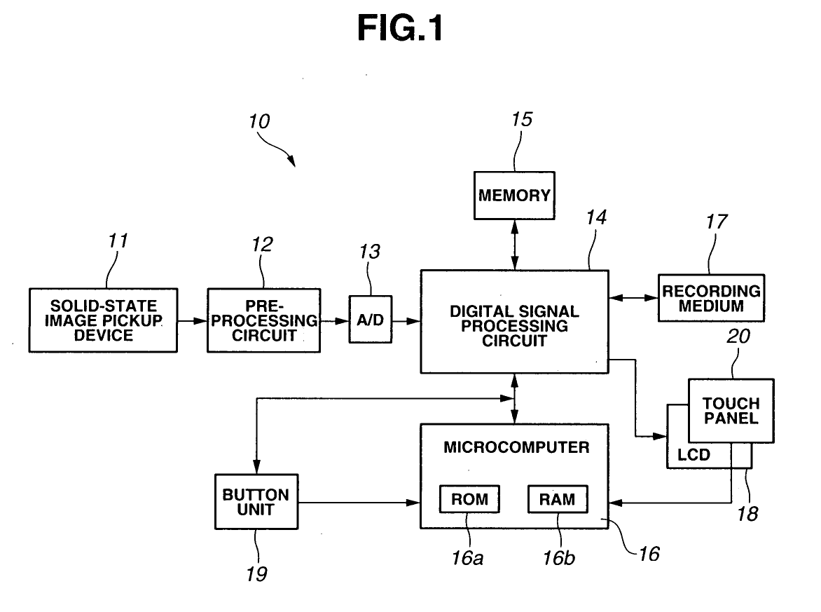

An image display apparatus according to an embodiment of the invention will be described with reference to FIGS. 1 to 5. An image display apparatus according to an embodiment of the invention is a small mobile apparatus such as a digital camera, a mobile information terminal apparatus (such as a PDA) and a mobile image viewer. An image display apparatus according to an embodiment of the invention will be described with reference to an example that the image display apparatus is a digital camera. FIG. 1 is a block diagram showing a construction of the digital camera, which is an image display apparatus according to one embodiment of the invention.

A digital camera (simply called camera, hereinafter) 10 includes a solid-state image pickup device 11, a signal pre-processing circuit 12, an analog signal/digital signal converter (called A/D converter hereinafter) 13, a digital signal processing circuit 14, a memory 15, a microcomputer 16, a recording medium 17, a liquid crystal display panel (called LCD hereinafter) 18, a button unit 19 and a touch panel 20.

The solid-state image pickup device 11 optoelectronically converts a subject image formed by an optical lens, not shown, and generates image-picked-up signals. The pre-processing circuit 12 performs analog signal processing such as amplification and filtering on image-picked-up signals generated by the solid-state image pickup device 11. The A/D converter 13 converts analog image-picked-up signals processed in the pre-processing circuit 12 to digital signals. The digital signal processing circuit 14 creates digital compressed data by processing digital signals from the A/D converter 13 by using JPEG method for still images and MPEG2 method for moving images and generates video signals to be displayed on the LCD 18 by expanding digital compressed data. The memory 15 temporarily stores digital image data created by the digital signal processing circuit 14. The microcomputer 16 controls driving of the digital signal processing circuit 14 and performs different kinds of control, which will be described later. The recording medium 17 is a semiconductor memory removably installed in the camera 10 from/to which digital image data temporarily stored in the memory 15 under the control of the microcomputer 16 can be written and read. The LCD 18 displays an image-picked-up image based on video signals expanded from digital image data created by the digital signal processing circuit 14. The button unit 19 includes multiple buttons for image-picking-up operations, such as a shutter button, a zoom button for an optical lens and a power switch. Signals based on operations on these buttons are supplied to the digital signal processing circuit 14. The touch panel 20 is provided on an image display screen of the LCD 18 for detecting a position touched by a user's finger or a pointer pen.

The microcomputer 16 has a ROM 16a and a RAM 16b. The ROM 16a stores a control program for controlling driving of the digital signal processing circuit 14, and the RAM 16b is used as a work area. The microcomputer 16 controls driving of the digital signal processing circuit 14 in accordance with a command input by a user through the button unit 19 and touch panel 20.

In the camera 10, when the power switch in the button unit 19 is turned on by a user, the solid-state image pickup device 11 is driven and a subject image is optoelectronically converted. The optoelectronically converted image-picked-up signals undergo predetermined signal processing such as amplification and filtering in the pre-processing circuit 12 and are converted to digital image-picked-up signals in the A/D converter 13. The digital image-picked-up signals undergo predetermined signal compressing processing in the digital signal processing circuit 14 under the control of the microcomputer 16, and digital image data is created therefrom. The digital image data is temporarily stored in the memory 15, read from the memory 15, expanded and displayed as an image-picked-up image on the LCD 18 under the control of the microcomputer 16. Furthermore, the digital image data read from the memory 15 is written to and stored in the recording medium 17. In other words, the LCD 18 is a display unit that displays a still image or moving images image-picked-up and signal-processed in the solid-state image pickup device 11 through the digital signal processing portion 14.

The touch panel 20 is provided on an image display screen of the LCD 18. The touch panel 20 detects a position (or coordinates) touched by a user with an object such as a finger or a pointer pen and outputs the result to the microcomputer 16 as detected position data. When a user touches an icon displayed at a specific position of the LCD 18 for indicating an operation mode required for an image-picking-up operation of the camera 10 through the touch panel 20, the operation mode selected by the user can be detected based on the touched position on the touch panel 20. In other words, the touch panel 20 is a position detecting unit that detects a position touched by an object on the touch panel screen.

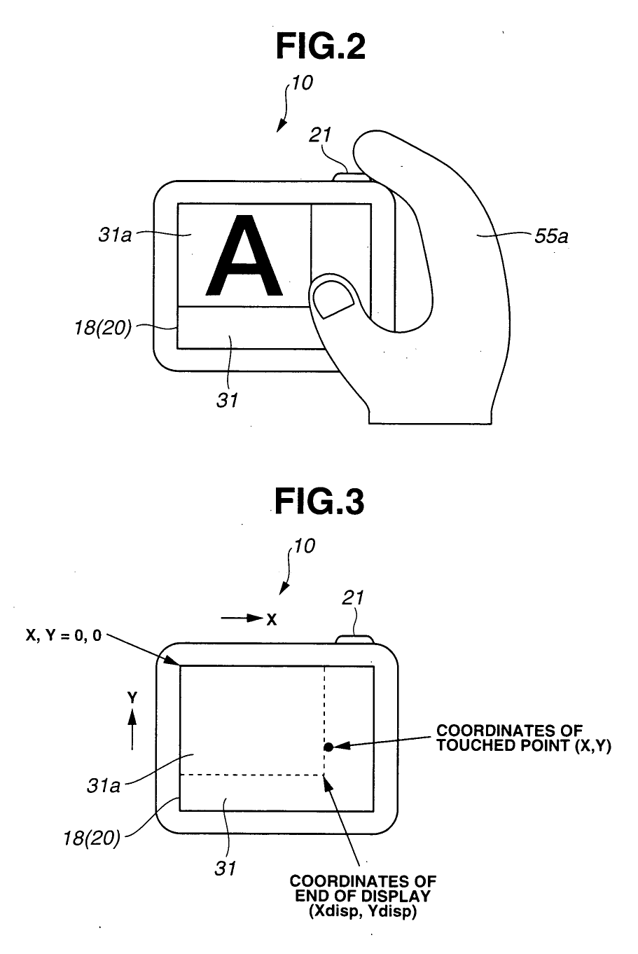

As shown in FIG. 2, the camera 10 has the LCD 18 for being arranged on a substantially entire area of the back face of the camera 10. When the camera 10 having the LCD 18 on a substantially entire area of the back face is held to pick-up images by a user with one hand as described above, the thumb finger of the right hand 55a may be placed on the image display screen 31 of the LCD 18 and cover a part of the image display screen 31, for example.

The camera 10 according to an embodiment of the invention detects a position of the thumb finger of the user's right hand 55a placed on the image display screen 31 of the LCD 18 by using the touch panel 20. The image display area 31a for displaying an image-picked-up image is set on the image display screen 31 of the LCD 18 with the detected position of the thumb finger avoided.

Though the image display area 31a set in this case displays an image in a reduced size, the entire image can be viewed without a part of the image covered by the user's finger.

An operation for setting the image display area 31a based on a detected position of a finger placed on the LCD 18 will be described with reference to FIGS. 3 to 5.

FIG. 3 shows a position touched by a user's finger on the LCD 18 having the touch panel 20 and the image display area 31a of the image display screen 31 of the LCD 18. A position on the image display screen 31 of the LCD 18 is expressed by X and Y coordinates where the horizontal axis is X and the vertical axis is Y. The upper left corner of the image display screen 31 in FIG. 3 has starting point coordinates (X,Y)=(0,0) of the image display area 31a. When a user's finger touches the touched point coordinates (X,Y) on the image display screen 31 in FIG. 3, the image display area 31a is set to be provided on a tangent of the touched point coordinates (X,Y).

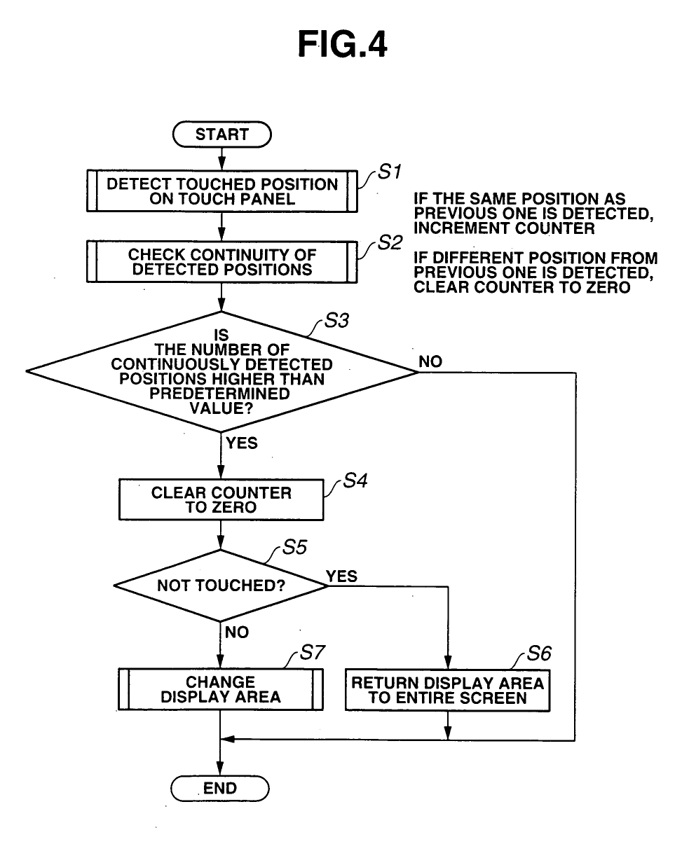

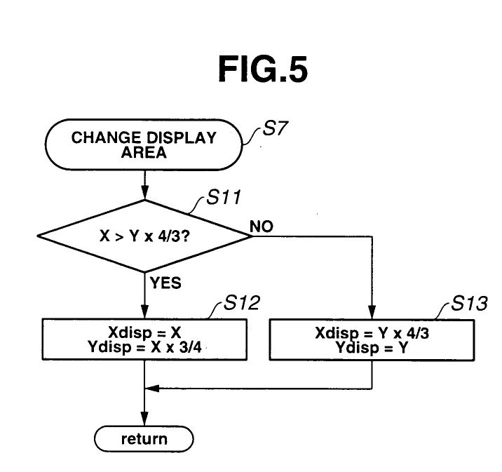

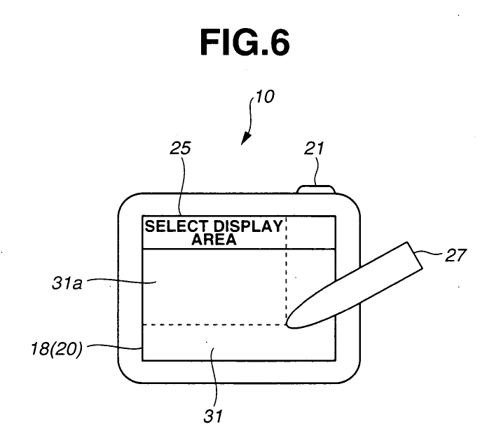

An operation of processing for setting a display area of the LCD 18 based on a detected position touched by a finger on the touch panel 20 will be described with reference to flowcharts in FIGS. 4 and 5. FIGS. 4 and 5 are flowcharts illustrating an operation of processing for setting an image display area of the LCD 18 under the control of the microcomputer 16 of the camera 10, which is an image display apparatus according to an embodiment of the invention.

The power switch, not shown, in the button unit 19 is turned on to enable the camera 10 to pick-up images. The microcomputer 16 performs an operation of detecting a position touched by a user's finger first when the camera 10 is enabled to pick-up images. In step S1, the microcomputer 16 controls the digital signal processing circuit 14 to detect coordinates of the position touched by a user's finger on the touch panel 20. In step S2, after a predetermined period of time from the detection of the coordinates of the first touched position, coordinates of a touched position are detected again. The coordinates of the first detected touched position and the coordinates of the touched position detected after the predetermined period of time therefrom are compared to determine whether the coordinates after the predetermined period of time therefor are the same as the coordinates of the previously detected touched position or not and check continuity of the coordinates of the detected positions thereby.

In step S2, if the coordinates of the previously detected touched position and the coordinates of the touched position detected after the predetermined period of time are the same, a position detecting counter is incremented. If the coordinates of the previously detected touched position and the coordinates of the touched position detected after the predetermined period of time are different, the position detecting counter is cleared to zero. Then, coordinates of a touched position on the touch panel 20 is detected again.

In step S3, the microcomputer 16 determines whether the state that coordinates of touched positions detected at predetermined time intervals are the same continuously occurs a predetermined number of times or not. In other words, whether a user's finger is touching the touch panel 20 continuously for a predetermined time or not is determined based on whether the count of the position detecting counter exceeds a predetermined value or not. If it is determined that the count of the position detecting counter does not exceed the predetermined value as a result of the determination in step S3, it is determined that the user's finger is not touching the touch panel 20, that is, the image display screen of the LCD 18. If it is determined that the user's finger is not touching it, the operation of detecting positions touched by a finger ends. Then, the method advances to processing for an image-picking-up mode for displaying an image on the entire area of the image display screen 31 of the LCD 18.

If it is determined that the count of the position detecting counter exceeds the predetermined value in step S3, that is, if the user's finger is touching the touch panel 20 continuously for the predetermined period of time, the microcomputer 16 clears the position detecting counter to zero in step S4.

Next, in step S5, the microcomputer 16 determines again whether a user's finger is continuously touching the touch panel 20 and the coordinates of a touched position are detected or not after the position detecting counter is cleared to zero in step S4. If it is determined in step S5 that a user's finger is continuously touching the touch panel 20, the microcomputer 16 in step S7 sets an image display area 31a to be displayed on the image display screen 31 of the LCD 18 and causes an image-picked-up image to be displayed on the image display area 31. If it is determined in step S5 that a user's finger is moved away from the touch panel 20 and coordinates of a touched position are not detected, an image-picked-up image is displayed on the entire area of the image display screen 31 of the LCD 18 again. The operation moves to an image-picking-up operation when the processing of setting the image display area 31a of the image display screen 31 of the LCD 18 ends in steps S6 and S7.

In other words, while a user's finger is partially covering and touching the image display screen 31 of the LCD 18, the image display area 31a avoiding the position where a user's finger is touching of the image display screen 31 of the LCD 18 is set, and an image-picked-up image is displayed. Furthermore, when a user's finger is moved away from and is not touching the image display screen 31 of the LCD 18, an image-picked-up image is displayed on the entire area of the image display screen 31 of the LCD 18.

Next, the processing of setting an image display area in step S7 will be described with reference to FIG. 5. Step S7 is an image display area setting unit in the microcomputer 16. In step S11, the image display area setting unit of the microcomputer 16 compares coordinates (X,Y) of finger-touched points detected by the touch panel 20. The comparison of the coordinates of touched points is based on determination whether the detected horizontal axis coordinate X is larger than the detected vertical axis coordinates Y×4/3 (that is, X>Y×4/3) or not where the image display screen 31 of the LCD 18 has an aspect ratio of 4:3.

If it is determined in step S11 that the detected horizontal axis coordinate X is larger than the detected vertical coordinates Y×4/3 (that is, X>Y×4/3), the display end coordinates of the image display area 31a on the image display screen 31 of the LCD 18 shown in FIG. 3 are set to a horizontal axis coordinate Xdisp=X and a vertical axis coordinate Ydisp=X×3/4 in step S12.

If it is determined in step S11 that the detected horizontal axis coordinate X is smaller than the detected vertical axis coordinate Y×4/3 (that is, X<Y×4/3), the display end coordinates of the image display area 31a on the image display screen 31 of the LCD 18 shown in FIG. 3 are set to a horizontal axis coordinate Xdisp=Y×4/3 and a vertical axis coordinate Ydisp=Y in step S13.

The microcomputer 16 detects, on the touch panel 20, coordinates of a position of a finger touching the image display screen 31 of the LCD 18 and automatically sets the image display area 31a within a tangent of the position at the touched coordinates of the image display screen 31 of the LCD 18 and causes an image-picked-up image to be displayed thereon.

In other words, the camera 10 automatically changes and sets the image display area 31a of the LCD 18 in order to prevent an image-picked-up image displayed on the LCD 18 from being covered by a user's finger.

Alternatively, the camera 10 can set the image display area 31a of the LCD 18 manually forcefully instead of automatic definition of the image display area 31a of the LCD 18.

In order to manually set the image display area 31a of the LCD 18 of the camera 10, a user causes an image display area selecting menu screen 25 to be displayed on the LCD 18 through a setting menu for operation modes contained in the camera 10 in advance. A user uses the image display area selecting menu screen 25 to command a display end position of the image display area 31a with a pointer pen 27, for example. After the display end position is commanded with the pointer pen 27, the same processing as detecting position coordinates, which has been described with reference to FIG. 4, and changing the image display area 31a of the LCD 18 based on detected position coordinates, which has been described with reference to FIG. 5, are performed.

A user may display the image display area selecting menu screen 25 before picking-up an image of a subject with the camera 10 and command a range of an image display area and display end position with the pointer pen 27, for example, so that the image display area 31a can be set manually forcefully.

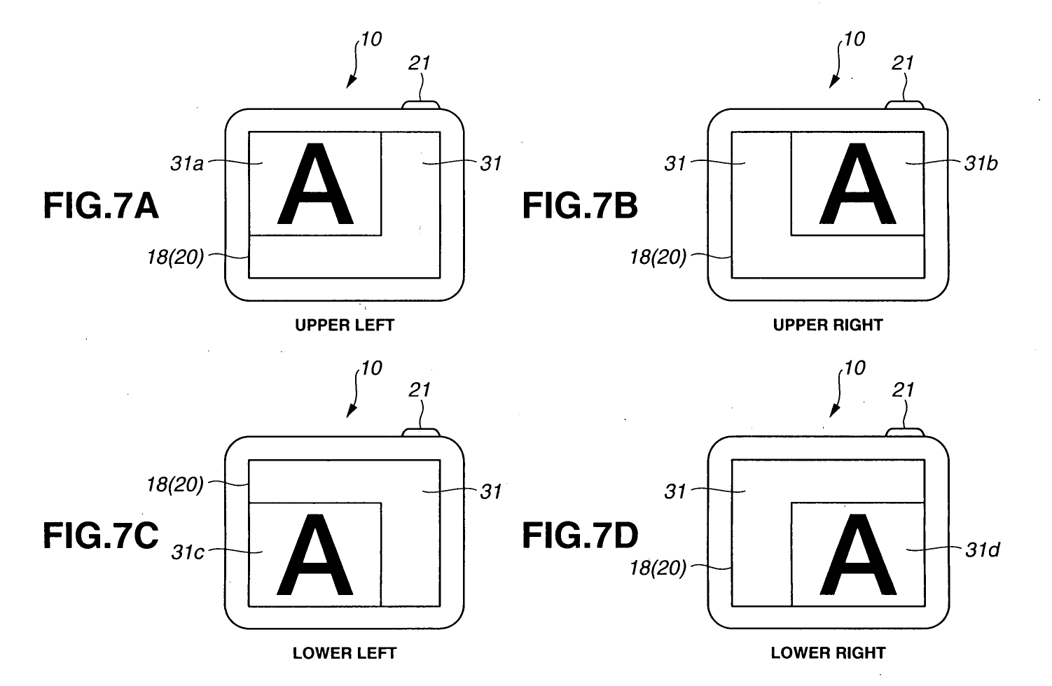

The hand holding the camera 10 for picking-up images is not limited to the right hand but may be the left hand. The camera 10 can set an image display area in the upper left, upper right, lower left or lower right part of the image display screen 31 of the LCD 18 such that the image display area may not be covered by a finger even when the camera 10 is held with either the left or right hand. FIGS. 7A to 7D show image display areas 31a to 31d in the upper left, upper right, lower left and lower right part of the image display screen 31.

As described above, in the setting of one of the image display area 31a to 31d, since coordinates of a position touched with a finger or the pointer pen 27, for example, on the touch panel 20 are display end coordinates of one of the image display area 31a to 31d, the starting point coordinates of the one of the image display area 31a to 31d are coordinates at a diagonal position of the coordinates of the detected touched position.

Therefore, when the coordinates of a touched position on the touch panel 20 is in a lower right part, the image display area 31a is displayed in an upper left part as shown in FIG. 7A. When the coordinates of a touched position on the touch panel 20 is in a lower left part, the image display area 31b is displayed in an upper right part as shown in FIG. 7B. When the coordinates of a touched position on the touch panel 20 is in an upper right part, the image display area 31b is displayed in a lower left part as shown in FIG. 7C. When the coordinates of a touched position on the touch panel 20 is in an upper left part, the image display area 31d is displayed in a lower right part as shown in FIG. 7D.

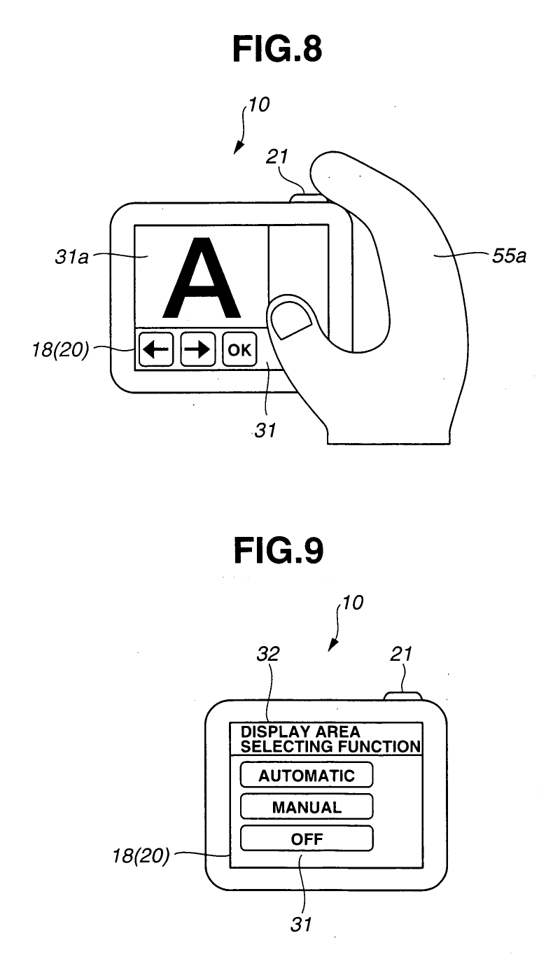

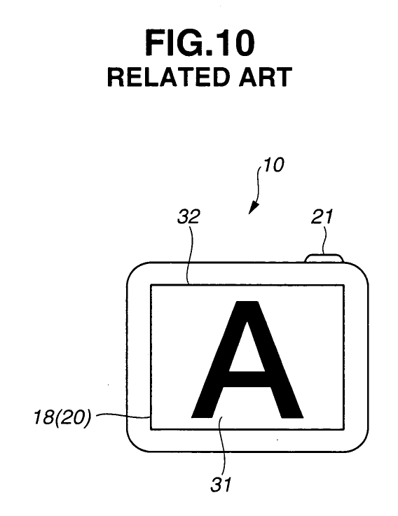

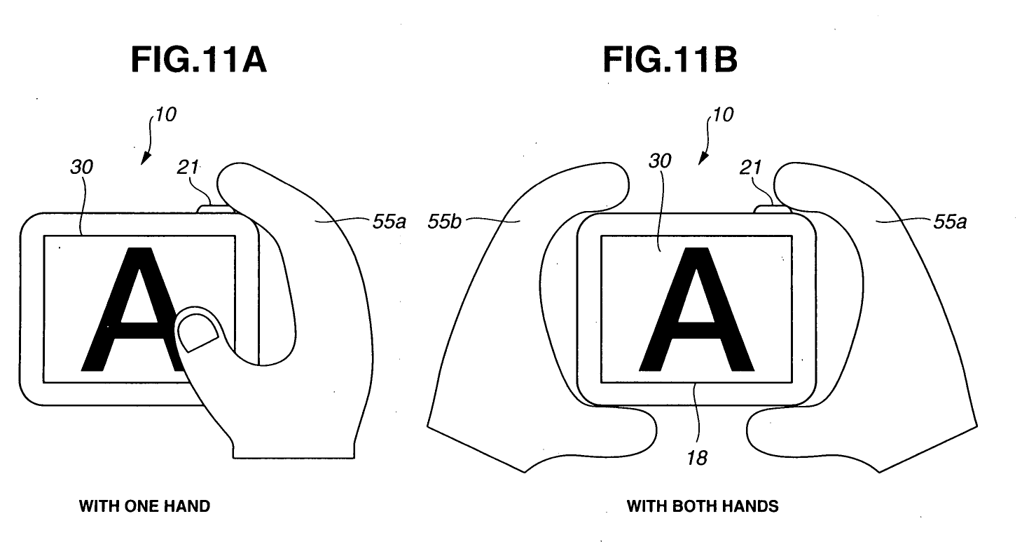

Furthermore, as shown in FIG. 8, the microcomputer 16 can display, on an area excluding the image display area 31a, arrow keys for commanding sequentially reading digital image data of an image-picked-up image to be displayed on the image display area 31a from the recording medium 17 or an icon for an operation menu such as an OK key for commanding continuous recording. Thus, the area excluding one of the image display areas 31a to 31d of the image display screen 31 can be effectively used.

The camera 10 has the shutter button 21 at a position easily operable generally with the index finger of the right hand. Thus, the camera 10 cannot be held with the left hand and cannot pick-up images with the left hand. In order to operate the camera 10 with the left hand, the manual method of setting an image display area is used to set the image display area 31b or 31d shown in FIG. 7B or 7B, respectively, on the image display screen 31. A shutter button icon is displayed at a position easily operable with the left hand in the part excluding the image display areas 31b or 31d of the image display screen 31. In response to a touch on the shutter button icon with a finger of the left hand, the touch panel 20 detects the manipulation on the shutter button icon, and a shutter operation is performed under the control of the microcomputer 16. Thus, image-picking-up can be performed by holding the camera 10 with the left hand, which can enhance the operability and convenience of the camera 10.

Furthermore, as described above, the camera 10 has two operation modes including an automatic mode for automatically setting one of the image display areas 31a to 31d on the image display screen 31 of the LCD 18 and a manual mode for manually forcefully setting one of the image display areas 31a to 31d with the pointer pen 27. In order to select the automatic mode or the manual mode, a command may be input to the microcomputer 16 through the button unit 19 first to display, on the LCD 18, an image display area selecting function menu 32 shown in FIG. 9 under the various operation menu of the camera 10. The image display area selecting function menu 32 has “AUTOMATIC”, “MANUAL” and “OFF” icons, desired one of which is selected. When “AUTOMATIC” is selected, a mode is activated in which a position of a user's finger is detected and a display area is automatically set. When “MANUAL” is selected, a mode is activated in which a display area commanded based on user's preference is set forcefully. When “OFF” is selected, the mode of changing a display area automatically or manually is cancelled.

As described above, the camera 10, which is an image display apparatus according to an embodiment of the invention, has a minimized space for the button unit 19 required for an image-picking-up operation so that the large LCD 18 and touch panel 20 on the image display screen 31 can be provided on the entire area of the back face of the camera 10. A user can enhance viewability of a displayed image-picked-up image by using the large LCD 18 on the image display screen 31. Furthermore, a user can view an entire displayed image by switching from one to another among the image display areas 31a to 31d in accordance with a position of an object including a user's finger touching the image display screen 31 of the LCD 18. Furthermore, the user's operability and convenience of the camera 10 can be enhanced by displaying an operation icon of the camera 10 along with one of the image display areas 31a to 31d on the image display screen 31 of the LCD 18.

While, in the description of the embodiments, a digital camera is adopted, for example, the invention is applicable to a mobile information terminal apparatus (such as a PDA), mobile image viewer and so on, each of which has a liquid crystal display panel for displaying a still image or moving images.

Having described the preferred embodiments of the invention referring to the accompanying drawings, it should be understood that the present invention is not limited to those precise embodiments and various changes and modifications thereof could be made by one skilled in the art without departing from the spirit or scope of the invention as set in the appended claims.

1. An image display apparatus, comprising:
a display unit for displaying a still image or moving images;
a position detecting unit for detecting a position of an object touching an image display screen of a display unit; and
a display area setting unit for setting a display area of an image to be displayed on the image display screen of the display unit in accordance with a position touched by an object, which is detected by the position detecting unit.

2. An image display apparatus, comprising:
a display unit for displaying a still image or moving images;
a forceful display area setting mode unit for setting an image display area of the display unit forcefully;
a position detecting unit for detecting a range of an image display area commanded on the image display screen of the display unit set by the forceful display area mode unit; and
a display area setting unit for setting a display area of an image to be displayed on the image display screen of the display unit in accordance with an image display range detected by the position detecting unit.

3. The image display apparatus according to claim 2, wherein the position detecting unit detects an end position of an image display area commanded on an image display screen of the display unit.

4. The image display apparatus according to claim 1 or 2, wherein icons for operation menus or operation information are displayed on a display area excluding an image display area of the image display screen of the display unit, which is set by the display area setting unit.

5. An image display method, comprising:
detecting a position touched by an object touching and covering an image displayed on a display unit that displays a still image or moving images; and
setting an image display area in accordance with the detected touched position such that an image displayed on the display unit can avoid the touched position.
